(19) United States
(12) Patent Application Publication
(10) Pub. No.: US 2017/0154107 A1
(43) Pub. Date: Jun. 1, 2017

(54) DETERMINING TERM SCORES BASED ON A MODIFIED INVERSE DOMAIN FREQUENCY

(71) Applicant: Hewlett Packard Enterprise Development LP, Houston, TX (US)

(72) Inventors: Morad Awad, Haifa (IL); Gil Elgrably, Haifa (IL); Mani Fischer, Haifa (IL); Renato Keshet, Haifa (IL); Mike Krohn, Bristol (GB); Alina Maor, Haifa (IL); Ron Maurer, Haifa (IL); Igor Nor, Haifa (IL); Olga Shain, Haifa (IL); Doron Shaked, Tivon (IL)

(21) Appl. No.: 15/325,807

(22) PCT Filed: Dec. 11, 2014
(86) PCT No.: PCT/US2014/069753

§ 371 Date: Jan. 12, 2017

(51) Int. Cl. G06F 17/30

(52) U.S. Cl. CPC G06F 17/30719

(57) ABSTRACT

Determining term scores based on a modified inverse domain frequency is disclosed. One example is a system including a data processing engine, an evaluator, and a data analytics module. The data processing engine identifies a key term associated with a system, and a sub-plurality of a plurality of documents, the sub-plurality of documents associated with the event. The evaluator determines, based on the presence or absence of the key term, a first distribution related to the sub-plurality of documents, and a second distribution related to the plurality of documents, and evaluates, for the key term, a term score based on the first distribution and the second distribution, the term score indicative of a modified inverse domain frequency based on the sub-plurality of documents. The data analytics module includes the key term in a word cloud when the term score for the key term satisfies a threshold.

### BACKGROUND

Documents are routinely searched and ranked based on term relevance of terms appearing in a given document or a corpus of documents. Terms may be weighted based on term frequency, term frequency/inverse document frequency, and so forth. Word clouds may be generated for visual depiction of weighted terms appearing in a document.

### BRIEF DESCRIPTION OF THE DRAWINGS

FIG. 1 is a functional block diagram illustrating an example of a system for determining term scores based on a modified inverse domain frequency,

FIG. 2 is a flow diagram illustrating an example algorithm for determining term scores based on a modified inverse domain frequency.

FIG. 3 is a block diagram illustrating an example of a processing system for implementing the system for determining term scores based on a modified inverse domain frequency.

FIG. 4 is a block diagram illustrating an example of a computer readable medium for determining term scores based on a modified inverse domain frequency.

FIG. 5 is a flow diagram illustrating an example of a method for determining term scores based on a modified inverse domain frequency.

FIG. 6 is a flow diagram illustrating an example of a method for determining term scores in service case resolutions.

FIG. 7 is a flow diagram illustrating an example of a method for determining term scores in operations analytics.

### DETAILED DESCRIPTION

Online documents are searched and/or ranked for a variety of applications. Generally, documents may be searched and/or ranked based on key terms appearing in the documents. Identifying relevance of key terms appearing in a document is crucial for the performance of efficient and accurate searches.

Determining term scores for key terms is useful in operations analytics where operations data is routinely analyzed. Operations analytics includes management of complex systems, infrastructure and devices. Complex and distributed data systems are monitored at regular intervals to maximize their performance, and detected anomalies are utilized to quickly resolve problems. In operations related to information technology, key terms may be used to understand log messages, and search for patterns and trends in telemetry signals that may have sematic operational meanings. Various performance metrics may be generated by the operational analytics, and operations management may be performed based on such performance metrics. Operations analytics is vastly important and spans management of complex systems, infrastructure and devices. In a big data scenario, the size of the volume of data often negatively impacts processing of query-based analytics. One of the biggest problems in big data analysis is that of formulating the right query. Automated analysis of data requires an ability to perform contextual searches based on key terms. All such operational activities rely on an ability to quickly search and identify issues, often based on key terms. Accordingly, determining term scores for key terms is key to performing insightful analytics.

Determining term scores for key terms is useful in a resolution of a service case. Key terms appearing in document descriptions related to a resolution of a past service case may provide critical information as to a resolution of a new service case. For example, past service cases that are most similar to a newly arrived one may be identified, and event data for the past service cases may be indicative of potential resolutions of the new service case. Accordingly, there is a strong need to create a search engine that retrieves the past service cases that are most similar to a newly arrived one, by comparing their textual descriptions.

More particularly, there is a need for a method to determine the importance of each key term appearing in a document description of the new service case, and identify past service cases based on such information. For example, a new call may be received at a service center, with a document description such as “Device screen not working properly”. The proposed method may be able to determine that the word “screen” is the most relevant key term in the document description for choosing, say, which R&D department to escalate the case to.

A word cloud may be generated to provide a visual representation of a plurality of words highlighting words based on a relevance of the word in a given context. For example, a word cloud may comprise key terms that appear in log messages associated with a selected system anomaly. As another example, a word cloud may include key terms appearing in service case descriptions for service cases. Words in the word cloud may be associated with term scores that may be determined based on, for example, relevance and/or position of a word in the log messages, as described herein.

There are several techniques to determine term scores, including, for example, term frequency, and term frequency/inverse document frequency (“TF-IDF”). However, such techniques may not be adequate in identifying the relevance of key terms in the context of event data. For example, the TF-IDF for a key term may be generally viewed as an information gain provided by a knowledge that the key term is in a document description. This may be deduced based on an assumption that the service cases are uniformly distributed. Accordingly, as disclosed herein, TF-IDF may be improved if the underlying measure is not assumed to be uniform, but is based on an appropriate weighting of the service cases, such as, for example, a term prominence frequency indicative of prominence of the key term in the document description.

In some examples, such modifications may not be adequate in identifying the relevance of key terms in the context of event data. Accordingly, as disclosed herein, a term score may be determined, the term score indicative of relevance of the key term in a resolution of a past service case. A combination of the term prominence frequency and the term score may therefore capture the frequency of a key term in a document description, and the relevance of the key term to a resolution of the service case associated with the document description. Also, for example, the term score may be determined based on a Kullback-Liebler Divergence (“KL-Divergence”). As described herein, the KL-Divergence may be viewed as a modified TF-IDF.

Event data provides information related to a system. In some examples, the event may be a new service case. For example, in service case resolutions, a new service case may be received for resolution. Also for example, in operations analytics, the event may be selection and/or detection of a system anomaly. For example, a domain expert may be provided with a visual representation of system anomalies and/or event patterns, and the domain expert may select a system anomaly and/or a system pattern.

A system anomaly is an outlier in a statistical distribution of data elements of input data. The term outlier, as used herein, may refer to a rare event, and/or a system that is distant from the norm of a distribution (e.g., an unexpected or remarkable event). For example, the outlier may be identified as a data element that deviates from an expectation of a probability distribution by a threshold value. The distribution may be a probability distribution, such as, for example, uniform, quasi-uniform, normal, long-tailed, or heavy-tailed. Generally, an anomaly processor may identify what may be “normal” (or expected, or unremarkable) in the distribution of clusters of events in the series of events, and may be able to select outliers that may be representative of rare situations that are distinctly different from the norm (or unexpected, or remarkable). Such situations are likely to be “interesting” system anomalies. In some examples, rare, unexpected and/or remarkable events may be identified based on an expectation of a probability distribution. For example, a mean of a normal distribution may be the expectation, and a threshold deviation from this mean may be utilized to determine an outlier for this distribution.

In some examples, the event data may be structured or unstructured. When event data is structured, there are a limited number of possible alternatives. For example, in a service case scenario, structured outcome data may indicate that there are only a limited number of potential resolutions for the service case. Also, for example, in operations analytics, structured outcome data may indicate that there are only a limited number of potential system anomalies and/or event patterns.

Accordingly, when the event data is structured, each key term may be mapped to one of the limited number of possible alternatives, thus simplifying the underlying probability distributions. When event data is unstructured, the number of possible alternatives may be large. In such instances, there is a need to determine the underlying probability distribution based on an outcome metric, the outcome metric indicative of distance between two outcomes of the unstructured outcomes. For example, in a service case scenario, event data may be service data, and the outcome metric may be resolution metric indicative of distance between two resolutions of past service cases.

As described in various examples herein, determining term scores based on a modified inverse domain frequency is disclosed. One example is a system including a data processing engine, an evaluator, and a data analytics module. The data processing engine identifies a key term associated with a system, and a sub-plurality of a plurality of documents, the sub-plurality of documents associated with the event. The evaluator determines, based on the presence or absence of the key term, a first distribution related to the sub-plurality of the plurality of documents, and a second distribution related to the plurality of documents, and evaluates, for the key term, a term score based on the first distribution and the second distribution, the term score indicative of a modified inverse domain frequency based on the sub-plurality of the plurality of documents. The data analytics module includes the key term in a word cloud when the term score for the key term satisfies a threshold.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

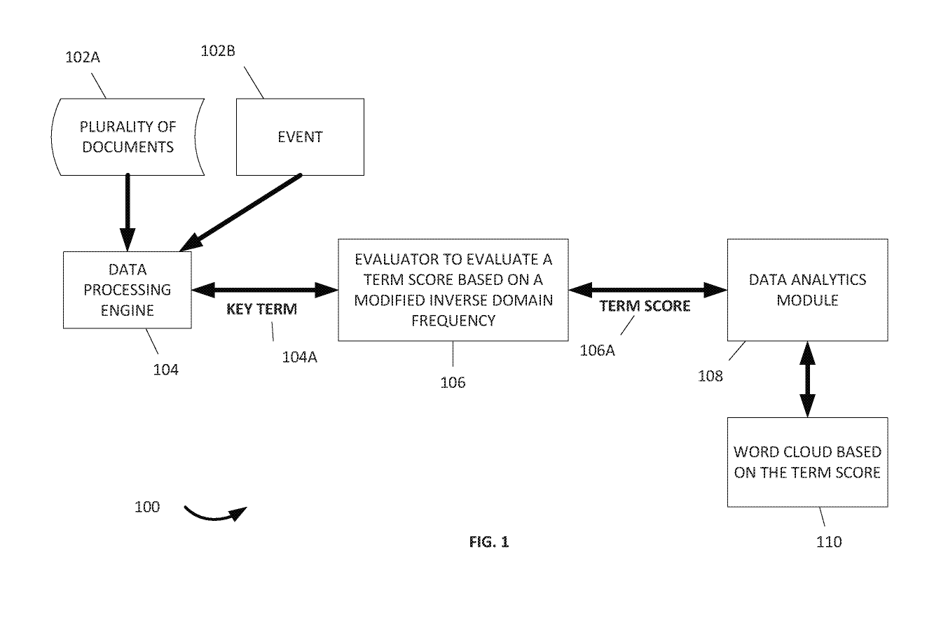

FIG. 1 is a functional block diagram illustrating an example of a system 100 for determining term scores based on a modified inverse domain frequency. System 100 is shown to include a data processing engine 104, an evaluator 106, and a data analytics module 108.

The term “system” may be used to refer to a single computing device or multiple computing devices that communicate with each other (e.g. via a network) and operate together to provide a unified service. In some examples, the components of system 100 may communicate with one another over a network. As described herein, the network may be any wired or wireless network, and may include any number of hubs, routers, switches, cell towers, and so forth. Such a network may be, for example, part of a cellular network, part of the Internet, part of an intranet, and/or any other type of network.

The components of system 100 may be computing resources, each including a suitable combination of a physical computing device, a virtual computing device, a network, software, a cloud infrastructure, a hybrid cloud infrastructure that includes a first cloud infrastructure and a second cloud infrastructure that is different from the first cloud infrastructure, and so forth. The components of system 100 may be a combination of hardware and programming for performing a designated function. In some instances, each component may include a processor and a memory, while programming code is stored on that memory and executable by a processor to perform a designated function.

The computing device may be, for example, a web-based server, a local area network server, a cloud-based server, a notebook computer, a desktop computer, an all-in-one system, a tablet computing device, a mobile phone, an electronic book reader, or any other electronic device suitable for provisioning a computing resource to determine term scores based on a modified inverse domain frequency. Computing device may include a processor and a computer-readable storage medium.

The system 100 identifies a key term associated with a system, and a sub-plurality of a plurality of documents, the sub-plurality of documents associated with the event. The system 100 determines, based on the presence or absence of the key term, a first distribution related to the sub-plurality of the plurality of documents, and a second distribution related to the plurality of documents. The system 100 evaluates, for the key term, a term score based on the first distribution and the second distribution, the term score indicative of a modified inverse domain frequency based on the sub-plurality of the plurality of documents. The system 100 includes the key term in a word cloud when the term score for the key term satisfies a threshold.

The data processing engine 104 may identify a key term associated with a system 102B, and a sub-plurality of a plurality of documents 102A, the sub-plurality of documents associated with the event 102B. For example, the event 102B may be a given service case, the plurality of documents 102A may be a collection of document descriptions for service cases, and the sub-plurality of the plurality of documents 102A may be a document description for the given service case. In some examples, the data processing engine 104 may receive event data for event 102B related to service cases, the event data including a document description for each of the service cases. In some examples, system 100 may receive event data directly from a service center that is processing service related requests. For example, a service center may be supporting a company that provides services related to information technology (“IT”). Customers receiving such IT services may contact the service center with service requests. In some examples, service requests may be received in the form of emails, text messages, transcribed text from voice messages, and so forth. In some example, employees at the service center may receive telephone calls from customers and may enter service requests into a database. In some examples, system 100 may retrieve event data from the database. Event data may also be received in additional and/or alternative ways.

In some examples, the event 102B may be a selected system anomaly, the plurality of documents 102A may be a collection of log messages, and the sub-plurality of the plurality of documents may be a sub-collection of the collection associated with the selected system anomaly. For example, a domain expert may be viewing an interactive visual representation of system anomalies and/or event patterns in the collection of log messages, and the domain expert may select a system anomaly and/or event pattern. In some examples, the selected system anomaly may correspond to a time interval, and may be associated with a collection of log messages appearing in the time interval.

The plurality of documents 102A may include textual and/or non-textual data. In some examples, the sub-plurality of the plurality of documents may be those that include the key term. In some examples, the sub-plurality of the plurality of documents may be identified based on temporal and/or spatial criteria associated with the key term.

For example, service cases may include document descriptions describing the service request. For example, a first document description may state “Lines are appearing on the screen.” As another example, a second document description may state “Laptop is not powering up”. Also, for example, a third document description may state “Track pad malfunctioning.”

Also, for example, log messages in operations analytics may include log messages such as “Date Time [Number] HP.BI INFO—Starting monitor operation against data ‘EDW Seaquest Production Database (EMR)’”. In some examples, log messages in operations analytics may include suitably normalized log messages such as “2013-07-16 04:54:55<2>”, where <2> is the class tag of the corresponding message “<Starting monitor operation against data ‘EDW<P> Production Database (<P>)’>.”

The data processing engine 104 may identify a key term associated with the event 102B. For example, the data processing engine 104 may identify a key term 104A in the document description for each of the service cases. For example, “Lines” and “screen” may be key terms 104A identified from the first document description. As another example, “Laptop” and “powering” may be key terms 104A identified from the second document description. Also, for example, “Track pad” and “malfunction” may be key terms 104A identified from the third document description. As described herein, key terms 104A may be utilized to identify a potential resolution of the service cases, based on past resolutions of past service cases. Also, as described herein, key terms 104A may be utilized to identify system anomalies and/or event patterns.

The evaluator 106 may determine, based on the presence or absence of the key term 104A, a first distribution related to the sub-plurality of the plurality of documents 102A, and a second distribution related to the plurality of documents 102A. The evaluator 106 may evaluate, for the key term 104A, a term score 106A based on the first distribution and the second distribution, the term score 106A indicative of a modified inverse domain frequency based on the sub-plurality of the plurality of documents 102A. To fully describe the many advantages described herein, a formal framework is formulated.

Let T be a set of terms, and C be document descriptions associated with the plurality of documents 102A. For example, C may be the collection of service case descriptions, or the collection of log messages. Every member c ∈ C has a document description T(c), which is a list of key terms in T, and possible outcomes R(c). The outcome may be an element of a given collection of outcomes R, as in structured resolution, or also a list of terms, as in unstructured resolution. An example of structured resolution is the name of a technician to whom a service case may be assigned. An example of unstructured resolution is a free-text description of how a service case may be resolved. In operations analytics, the outcome may also be an associated system anomaly and/or event pattern.

For each key term t in the list of terms in T, a mapping I may be defined, where the mapping represents relevance of the key term t for a search for an outcome. More formally, a map I:T→ [symbol] ₊ may be defined mapping a key term t in the list of terms in T to a non-negative real number in [symbol] ₊. The most pervasive method for assigning importance to terms is the TF-IDF method. The TF-IDF for a key term t may be defined as

$$TF \text{-} IDF ( t ) = log ( \frac{\vert C \vert}{\vert {C}_{t} \vert} )$$

where C is a plurality of documents (or document descriptions), and Cₜ is the sub-plurality of documents (or document descriptions) containing the key term t. TF-IDF may not always be adequate to determine relevance of a key term in the context of case resolutions and/or operations analytics. In fact, it may be useful to utilize the case resolution and/or the system anomaly as a guide to determine the relevance of a key term.

In some examples where C is assumed to be associated with a uniform distribution, the TF-IDF may be realized as a KL-Divergence. Generally, the KL-Divergence between two probability distributions, a first distribution pₐ, and a second distribution p_{b}, is given by:

$${D}_{KL} \{ {p}_{a} ‖ {p}_{b} \} = {\sum }_{i} {p}_{a} ( c ) log \frac{{p}_{a} ( c )}{{p}_{b} ( c )} \qquad ( Eqn . 1 )$$

where D_{KL}[•∥•] is the KL-Divergence operator, and c runs over all the values in the domain of the distributions pₐ and p_{b}. In the case of TF-IDF, the domain is the set of all documents (e.g., services case descriptions or log messages) in the plurality of documents, pₐ may be pₜ(c), the probability that the document description e containing the term t is chosen among all documents with term t:

$${p}_{t} ( c ) = \{ \begin{matrix}\frac{1}{\vert {C}_{t} \vert} , & if t in c \\ 0 , & otherwise\end{matrix} \qquad ( Eqn . 2 )$$

and p_{b} is p(c), the probability of choosing a document:

$$p ( c ) = \frac{1}{\vert C \vert} \qquad ( Eqn . 3 )$$

### Accordingly,

$${D}_{KL} \{ {p}_{t} ‖ p \} = {\sum }_{c ∈ C} {p}_{t} ( c ) log \frac{{p}_{t} ( c )}{p ( c )} = {\sum }_{c ∈ {C}_{t}} \frac{1}{\vert {C}_{t} \vert} log \frac{\vert C \vert}{\vert {C}_{t} \vert} = log \frac{\vert C \vert}{\vert {C}_{t} \vert} {\sum }_{c ∈ {C}_{t}} \frac{1}{\vert {C}_{t} \vert} == log \frac{\vert C \vert}{\vert {C}_{t} \vert} = IDF ( t ) \qquad ( Eqn . 4 )$$

Accordingly, as described herein, the TF-IDF may be modified, as in KL-Divergence, to be based on a first distribution related to the sub-plurality of the plurality of documents, and a second distribution related to the plurality of documents.

### Term Score Based on a Non-Uniform Distribution

In many instances, the service cases and/or log messages that include the key term t may not be equally weighted. In such instances, the evaluator 106 may determine a term prominence frequency indicative of prominence of the key term t in the sub-plurality of documents. For example, the term prominence frequency may be indicative of prominence of the key term t in the case description, or in a log message associated with the key term and/or a system anomaly. The term prominence frequency may be utilized to distinguish between documents that include the key term t. For example, the key term t may be more prominent in a first document description than in a second document description. Accordingly, the first document description may be assigned a greater weight than the second document description. Accordingly, the collection of document descriptions C may no longer be associated with a uniform distribution. In fact, based on such unequal weights of document descriptions, the collection of document descriptions C may be associated with a non-uniform distribution. Based on such considerations, the term prominence frequency may be defined as a function ƒₜ(c), the frequency of a key term t in a document description c. In some examples, the term prominence frequency may be a frequency of a term tin a document description c.

In some examples, the term prominence frequency may be defined as

$${f}_{t} ( c ) = exp \{ \frac{- {[ \frac{1}{τ ( t , c )} - 1 ]}^{2}}{2 {σ}^{2}} \} \qquad ( Eqn . 5 )$$

where τ(t,c) is the number of appearances of the key term t in a document description c divided by the total number of key terms in c. In some examples, τ(t, c)<<σ, and accordingly, fₜ(c) may be close to one. In some examples, τ(t, c)>>σ, and accordingly, fₜ(c) may be close to zero. In some examples, σ=10 may be utilized. As described, the function ƒₜ(c) may represent a term frequency. However, the function ƒₜ(c) may represent other criteria representative of a document description. For example, in some examples, the function ƒₜ(c) may represent a position of the key term t inside the document description c.

The function ƒₜ(c) may be transformed to a distribution pₜ(c) on the collection of document descriptions C via a process of normalization and regularization. For example, we may define the distribution as:

$${p}_{t} ( c ) = \frac{[ {f}_{t} ( c ) + η ]}{{\sum }_{{c}^{′} ∈ C} [ {f}_{t} ( {c}^{′} ) + η ]} \qquad ( Eqn . 6 )$$

In Eqn. 6, the variable η is a data regularization factor, which reduces the probability distribution pₜ(c) for infrequent terms (e.g., typos). In some examples, η=1 may be utilized. Based on the probability distribution pₜ(c), an entropy H(C|t) may be computed, thereby providing a modified TF-IDF. For example, the TF-IDF may now be modified to determine the term score based on a non-uniform distribution as:

I(t)=H(C)−H(C|t) (Eqn. 7)

In some instances, the term score in Eqn. 7 may not be adequate. For example, the term score for the key term may not satisfy a threshold criterion, and may therefore be inadequate for a quick and efficient resolution of service cases. For example, the TF-lDF may provide the relevance of a term in helping code the identity of an individual service case. However, in a service case scenario, a desired outcome goal may not be to find a relevant service case, but ultimately to find a relevant resolution for the service case. Accordingly, case resolution information may need to be incorporated, where the case resolution information is retrieved from a database D of resolutions of past cases. As described herein, in some examples, the term score may be based on a term relevance score indicative of indicative of relevance of the key term to the event. For example, the term relevance score may be indicative of relevance of the key term in a potential resolution of the service case. Such a term score may be evaluated for structured and unstructured resolutions.

### Term Score for Structured Outcomes

In some examples, the event 102B may be associated with event data that includes structured outcomes. The evaluator 106 evaluates the term score for the key term 104A based on a probability of the key term resulting in a selection of an outcome in the structured outcomes. When event data is structured, there is a small collection of outcomes R. A key term t may be determined to be relevant, if the key term t may be mapped to an outcome in the collection of outcomes R. For example, a key term t may be determined to be relevant to a resolution of a service case if the key term t may be mapped to a resolution of the structured resolutions. Likewise, a key term t may be determined to be relevant to a system anomaly in a log message if the key term t may be mapped to a system anomaly of the structured system anomalies.

More formally, pₜ(r) may represent the probability of a key term t leading to the outcome r ∈ R, which may be computed by normalizing a function ƒₜ(r)=Σ_{c∈C} ƒₜ(c) I(r,c)+η, where I(r,c), c) is the probability of the document description c having an outcome r ∈ R, and η is the normalization data regularization factor, as for example, in Eqn. 7. In some examples, every service case c may be assigned to a single resolution r. In such examples, I(r,c) is an indicator function: I(r,c)=0 when the service case c is assigned to resolution r. and I(r,c)=0 when the service case c is not assigned to resolution r. In some examples, every log message c may be assigned to a single system anomaly r. In such examples, I(r,c) is an indicator function: I(r,c)=1 when the log message c is assigned to system anomaly r, and I(r,c)=0 when the log message c is not assigned to system anomaly r.

A regularized probability, p(r) may be defined, the regularized probability indicative of a probability of obtaining outcome r when a service case is drawn with uniform distribution. In some examples,

$$p ( r ) = \frac{f ( r )}{{\sum }_{{r}^{′} ∈ R} f ( r )} \qquad ( Eqn . 8 )$$

where

ƒ(r)=Σ_{c∈C}pᵤ(c) I(r,c)+η (Eqn. 9)

where pᵤ(c) is the probability of a service case c being drawn with uniform distribution. As already described, entropies may be determined, based on probability distributions. For example, a first entropy H(R) may be determined based on the probability distribution p(r), and a second entropy H(R|t) may be determined based on the probability distribution pₜ(r). Accordingly, the term score for the structured outcome may be determined as:

I_{R}(t)=H(R)−H(R|t) (Eqn. 10)

Also, for example, the term score may be determined as the KL-Divergence between the probability distributions pₜ(r) and p(r), i.e.

Term Score=D_{KL}{pₜ(r)∥p(r)} (Eqn. 11)

### Term Score for Unstructured Outcomes

In some examples, where the event data 102 includes unstructured outcomes, the evaluator 106 evaluates the term score on an outcome metric, the outcome metric indicative of distance between two outcomes of the unstructured outcomes. An unstructured outcome is a free-text description, such as, for example, of how a service case may be resolved, or a system anomaly may be analyzed. In some examples, an outcome metric may measure proximity of such free-text descriptions to each other. For example, key terms from two free-text descriptions may be identified, and a proximity of the two free-text descriptions may be determined based, for example, on an aggregation of similarity scores for the respective key terms.

More formally, the d(c,b) may denote the distance between outcomes b and c according to the outcome metric. The structured outcome may be obtained as a particular instantiation of the unstructured case. For example, when d(c,b) is binary in the sense that d(c,b)=0 when b and c have the same outcome, whereas d(c,b)=∞ when b and c do not have the same outcome.

In some examples, the term score for such unstructured outcomes, may be determined by assigning a higher weight to a key term that may be associated with case outcomes that are proximate to each other based on the outcome metric. In some examples, the evaluator 106 further evaluates a continuous density signal based on the outcome metric. Evaluator 106 evaluates such a term score by transforming the distance information from the outcome metric into a continuous density signal, and by computing a continuous entropy for this continuous density signal, as described herein.

To determine such a continuous density signal, the outcome metric may be mapped to Euclidean space. In some examples, an operator p may map every service case to an outcome point in an Euclidean space E, where distances between outcomes are given by the outcome metric d. For example, the outcome metric d may represent a distance between resolutions of a service case. For example, for a pair of service cases b and c, a distance in Euclidean space E may be defined as d_{E}(p(b), p(c))=d(c, b), where d_{E} is the distance in Euclidean space E. For a probability distribution p on the collection of document descriptions (e.g., service cases, log messages) C, a density signal may be determined as a continuous function

D_{p (}x)=Σ_{c∈C}k[ρ(c)−x]p(c), (Eqn. 12)

where x is a point in Euclidean space E, and k is a translational kernel defined on E. The integral of k over E may be required to be 1. In some examples, this may be achieved by selecting k as a zero-mean Gaussian distribution with variance σₖ. As may be determined, the integral of Dₚ(x) over E is 1, and accordingly, Dₚ(x) may represent a probability density function. Based on such considerations, an entropy may be determined as:

H(Dₚ)=−∫Dₚ(x)log Dₚ(x)dx (Eqn. 13)

Accordingly, the term score for the unstructured outcome may be determined as:

I_{D(}T)=H(D_{ρ}_{ᵤ})−H(Dₚ_{ₜ}) (Eqn.14)

In some examples, the determination of the information gain may be understood in terms of channel capacity. For example, R=p(C) may be interpreted as a channel input, where C has distribution ρ, and K is the k—distributed noisy media. Accordingly, the information transmittable over channel C, or the channel capacity for the given distribution p may be given as:

H(Dₚ)−H(K) (Eqn. 15)

This information gain may be viewed as a difference between a non-conditioned channel capacity, with ρ=ρᵤ, and a t-conditioned channel capacity, with ρ=ρₜ. Accordingly, the information gain I(t)=H(D_{ρ}_{ᵤ})−H(D_{ρ}_{ₜ})=I_{D}(t). In particular, when K is the Dirac delta operator, the term score given by Eqn. 15 is identical to the term score given by Eqn. 14, i.e.:

I_{R}(t)=I_{D}(t) (Eqn. 16)

In some examples, an approximate term score I_{D} may be computed directly on the collection of service cases C. In some examples, this may remove and/or reduce the need to work in a higher-dimensional Euclidean space E.

In some examples, the term score may be determined as the KL-Divergence between the probability distributions Dₚₜ and Dₚᵤ:

$$Term Score = {I}_{D} ( t ) = {D}_{KL} \{ {D}_{{ρ}_{t}} ‖ {D}_{{ρ}_{u}} \} = \int {D}_{{ρ}_{t}} ( x ) log \frac{{D}_{{ρ}_{t}} ( x )}{{D}_{{ρ}_{u}} ( x )} d x \qquad ( Eqn . 17 )$$

In some examples, a discrete form of Eqn. 17 may be utilized to determine the term score. For example, if a service case may be associated with a resolution, a value 1 may be assigned to the service case. On the other hand, if the service case may not be associated with a resolution, a value 0 may be assigned to the service case. Also for example, if a log message may be associated with a system anomaly, a value 1 may be assigned to the log message. On the other hand, if the log message may not be associated with a system anomaly, a value 0 may be assigned to the log message. Accordingly, the term score may be computed as:

$${D}_{KL} \{ {p}_{t} ‖ p \} = {p}_{t} ( 0 ) log \frac{{p}_{t} ( 0 )}{p ( 0 )} + {p}_{t} ( 1 ) log \frac{{p}_{t} ( 1 )}{p ( 1 )} , \qquad ( Eqn . 18 )$$

which is a discretized version of Eqn. 17.

In some examples, the data may be large and/or the number of messages in the log messages associated with the system anomaly may be small relative to the total number of messages. Also, for example, the number of case descriptions may be small as compared to the total number of case descriptions. In such instances, the term score based on Eqn. 18 may not be stable. For example, pₜ(1) may tend to zero and the result in the limit may not depend on the sub-plurality of documents associated with the event.

In some examples, the term score may be determined based on a modification of the formula in Eqn. 18. More formally, instead of a first distribution pₜ={pₜ(0), pₜ(1)} and a second distribution p={p(0), p(1)}, as utilized in Eqn. 19, a first distribution pᵢ={p₁(t), p₁(−t)} and a second distribution p₀={p₀(t), p₀(−t)}, may be defined as follows:

p₁(t)=pₜ(1)

p₀(t)=pₜ(0)

p₁(−t) is the probability of the term t not appearing in an anomaly message

p₀(−t) is the probability of the term t not appearing in an non-anomaly (normal) message

Accordingly, Eqn. 18 may be modified to obtain:

$${D}_{KL} \{ {p}_{1} ‖ {p}_{0} \} = {p}_{1} ( t ) log \frac{{p}_{1} ( t )}{{p}_{0} ( t )} + {p}_{1} ( - t ) log \frac{{p}_{1} ( - t )}{{p}_{0} ( - t )} \qquad ( Eqn . 19 )$$

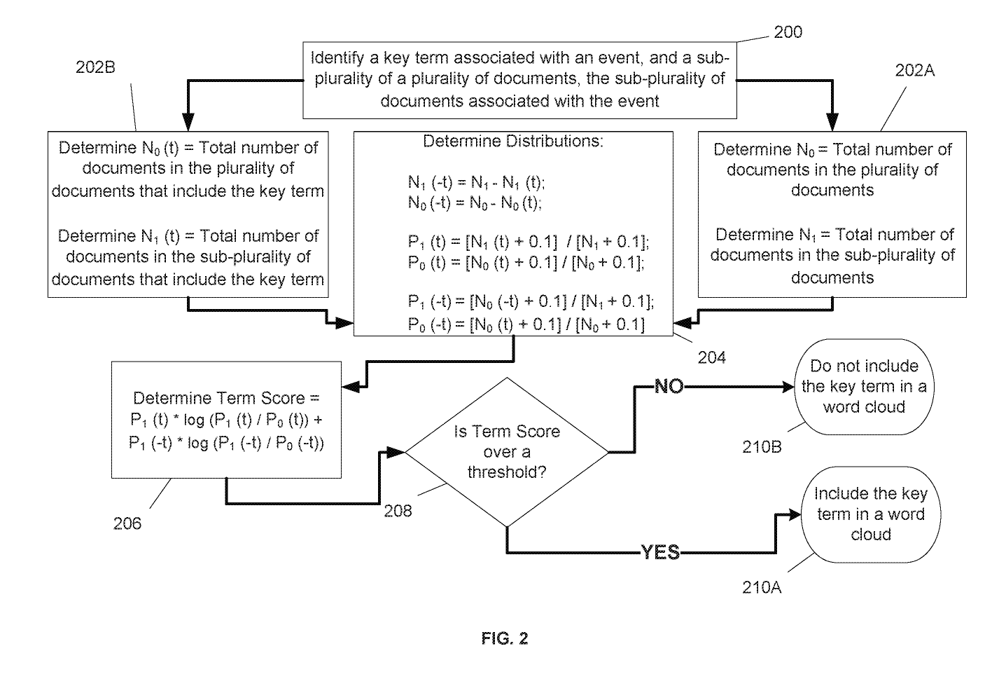

FIG. 2 is a flow diagram illustrating an example algorithm for determining term scores based on a modified inverse domain frequency. As described herein, in some examples, the term score may be based on a modified inverse domain frequency, as provided by Eqn. 19.

At 200, a key term associated with a system is identified, and a sub-plurality of a plurality of documents are identified, the sub-plurality of documents associated with the event.

At 202A, a total number of documents in the plurality of documents is determined and denoted as N₀. For example, N₀ may represent the number of log messages, or the number of case descriptions.

Also, a total number of documents in the sub-plurality of documents is determined and denoted as N₁. For example, N₁ may represent the number of log messages associated with a selected system anomaly, or the number of case descriptions received.

At 202B, a total number of documents (in the plurality of documents) including the key term is determined and denoted as N₀(t). For example, N₀(t) may represent the number of log messages that include the key term, or the number of case descriptions that include the key term.

Also, a total number of documents (in the sub-plurality of documents) including the key term is determined and denoted as N₁(t). For example, N₁(t) may represent the number of log messages (associated with a selected system anomaly) that include the key term, or the number of case descriptions (received) that include the key term.

At 204, additional quantities may be determined as:

N₁(−t)=N₁−N₁(t); and

N₀(−t)=N₀−N₀(t).

A first distribution P₀ and a second distribution P₁ may be determined, where “0” is indicative of absence of a key term (e.g., in a case description or log message), and “1” is indicative of a presence of a key term. (e.g., in a case description or log message):

P₁(t)=[N₁(t)+0.1]/[N₁+0.1];

P₀(t)=[N₀(t)+0.1]/[N₀+0.1];

P₁(−t)=[N₀(−t)+0.1]/[N₁+0.1]; and

P₀(−t)=[N₀(t)+0.1]/[N₀+0.1].

At 206, a term score based on a modified inverse domain frequency may be determined based on Eqn. 19, as follows:

Term Score=P₁(t)*log [P₁(t)/P₀(t)]+P₁(−t)*log [P₁(−t)/P₀(−t)] (Eqn. 20)

Data Analytics Module 108 may include the key term in a word cloud when the term score 106A for the key term 104A satisfies a threshold. For example, the data analytics module 108 may generate a word cloud based on the sub-plurality of documents. In some examples, the word cloud may include additional key terms identified from the sub-plurality of documents. For example, the word cloud may include additional key terms in received service case descriptions. Also, for example, the word cloud may include additional key terms in the log messages associated with a selected system anomaly. A threshold may be determined, and the key word may be included in the word cloud if the term score satisfies a threshold value.

Referring again to FIG. 2, at 208, it may be determined if the term score is over a threshold. If it is, then at 210A, the term score is included in the word cloud. If it is not, then at 210B, the term score is not included in the word cloud.

In some examples, the data analytics module 108 may display the word cloud 110 via an interactive graphical user interface, where the key term may be highlighted based on the term score. In some examples, the evaluator 106 may determine term scores for additional key terms in the sub-plurality of documents. In some examples, the data analytics module 108 may rank the key term and additional key terms based on respective term scores. The word cloud 110 may display the key terms and additional key terms based on their respective ranks and/or term scores. For example, the word cloud may highlight key terms that appear in anomalous messages more than those that do not. In some examples, relevance of a word may be illustrated by its relative font size in the word cloud. For example, “gueuedtoc”, “version”, and “culture” may be displayed in relatively larger font compared to the font for other key terms. Accordingly, it may be readily perceived that the key terms “queuedtoc”, “version”, and “culture” appear in the log messages related to the selected system anomaly more than in other log messages.

In some examples, the data analytics module 108 may provide a potential resolution of a given service case based on the term score, For example, event data associated with event 102B may include a service description such as “Device screen not working properly”. The data processing engine 104 may identify “Screen” as a key term 104A. The evaluator 106 may evaluate a term score 106A for the key term “Screen”. Based on the term score 106A, the data analytics module 108 may access a database (not shown in FIG. 1) to find case resolutions of past service cases associated with the key term “Screen”. In some examples, the data analytics module 108 may display a word cloud highlighting the key term “Screen”, In some examples, the data analytics module 108 may select a potential resolution of the service case based on the term score 106A.

In some examples, the data analytics module 108 may be communicatively linked to an anomaly processor (not shown in the figures) that detects system anomalies and/or event patterns based on the event 1028. The anomaly processor may detect presence or absence of a system anomaly in the plurality of semi-structured log messages, the system anomaly indicative of a rare event that is distant from a norm of a distribution based on the series of events. Whereas a system anomaly is generally related to insight into operational data, event patterns indicate underlying sematic processes that may serve as potential sources of significant semantic anomalies.

In some examples, the data analytics module 108 may be communicatively linked to a pattern processor (not shown in the figures). The pattern processor may detect presence or absence of a system pattern in the plurality of semi-structured log messages. Generally, the pattern processor identifies non-coincidental situations, usually events occurring simultaneously. Patterns may be characterized by their unlikely random reappearance. For example, a single co-occurrence in 100 may be somewhat likely, but 90 co-occurrences in 100 is much less likely.

In some examples, the data analytics module 108 may be communicatively linked to an interaction processor (not shown in the figures) to provide, via an interactive graphical user interface, the detected system anomalies and event patterns. In some examples, the interaction processor may be communicatively linked to the anomaly processor and the pattern processor. The interaction processor generates an output data stream based on the presence or absence of the system anomaly and the event pattern.

In some example, the data analytics module 108 receives feedback data from, for example, the interactive graphical user interface, and provides the feedback data to the evaluator 106. For example, the output may be a corresponding stream of event types according to matching regular expressions as determined herein. In some examples, the data analytics module 108 may determine, based on feedback data, that a potential resolution is not selected to actually resolve the service case. In some examples, the data analytics module 108 may determine that a system anomaly and/or event pattern is not selected by a domain expert. Such feedback data may be provided to the evaluator to modify the evaluation of the term score. For example, the term prominence frequency and/or the term relevance score for the key term associated with event may be modified.

In some examples, the data analytics module 108 modifies the term score of the key terms based on feedback data related to the interactive word cloud. For example, the data analytics module 108 may provide a potential resolution of a service case, based on a term score for a first key term. However, feedback data may indicate that a domain expert may select a second key term in the word cloud to further analyze the service case. Accordingly, the data analytics module 108 may provide the evaluator 106 and/or the data processing engine 104 with this feedback data. In some examples, the term score for the first key term may be modified to indicate a lesser degree of association with the potential case resolution. In some examples, the term score for the second key term may be modified to indicate a higher degree of association with the potential case resolution.

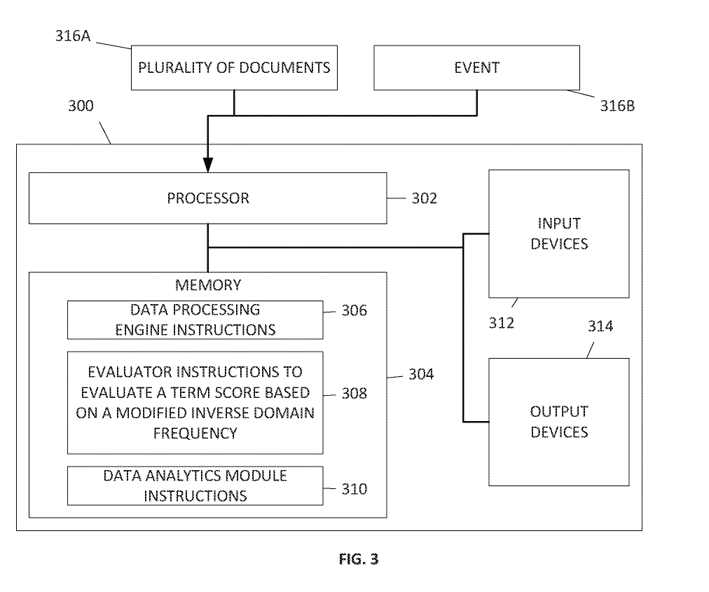

FIG. 3 is a block diagram illustrating some examples of a processing system 300 for implementing the system 100 for determining term scores based on a modified inverse domain frequency. Processing system 300 includes a processor 302, a memory 304, input devices 312, and output devices 314. Processor 302, memory 304, input devices 312, and output devices 314, are coupled to each other through communication link (e.g., a bus).

Processor 302 includes a Central Processing Unit (CPU) or another suitable processor. In some examples, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory.

Memory 304 stores instructions to be executed by processor 302 including instructions for a data processing engine 306, an evaluator 308, and a data analytics module 310. In some examples, data processing engine 306, evaluator 308, and data analytics module 310, include data processing engine 104, evaluator 106, and data analytics module 108, respectively, as previously described and illustrated with reference to FIG. 1.

Processor 302 executes instructions of data processing engine 306 to identify a key term associated with a system 316B, and a sub-plurality of a plurality of documents 316A, the sub-plurality of documents associated with the event 316B. In some examples, processor 302 executes instructions of data processing engine 306 to receive event data related to event 316B related to service cases, the event data including a service description for each of the service cases. Processor 302 executes instructions of data processing engine 306 to identify key terms in the service description for each of the service cases. In some examples, processor 302 executes instructions of data processing engine 306 to identify selection of a system anomaly, and identify log messages and key terms associated with the selected system anomaly.

Processor 302 executes instructions of evaluator 308 to determine, based on the presence or absence of the key term, a first distribution related to the sub-plurality of the plurality of documents, and a second distribution related to the plurality of documents. Processor 302 also executes instructions of evaluator 308 to evaluate, for the key term, a term score based on the first distribution and the second distribution, the term score indicative of a modified inverse domain frequency based on the sub-plurality of the plurality of documents.

In some examples, processor 302 executes instructions of evaluator 308 to evaluate the term score based on an information gain and a Kullback-Liebler Divergence. In some examples, processor 302 executes instructions of evaluator 308 to evaluate the term score based on a term prominence frequency indicative of prominence of the key term in the sub-plurality of documents. In some examples, processor 302 executes instructions of evaluator 308 to evaluate the term score based on a term relevance score indicative of relevance of the key term to the event.

In some examples, event data includes structured outcomes, and the processor 302 executes instructions of evaluator 308 to evaluate the term score for the key term based on a probability of the key term resulting in an outcome of the structured outcomes.

In some examples, event data 316 includes unstructured resolutions, and the processor 302 executes instructions of evaluator 308 to evaluate the term score based on an outcome metric, the outcome metric indicative of distance between two outcomes of the unstructured outcomes. In some examples, processor 302 executes instructions of evaluator 308 to further evaluate a continuous density signal based on the outcome metric.

Processor 302 executes instructions of a data analytics module 310 to include the key term in a word cloud when the term score for the key term satisfies a threshold. In some examples, processor 302 executes instructions of the data analytics module 310 to display, via an interactive graphical user interface, an interactive word cloud of key terms, wherein key terms are highlighted in the word cloud based on respective term scores. In some examples, processor 302 executes instructions of the data analytics module 310 to modify the term score of the given key term based on feedback data related to the interactive word cloud. In some examples, processor 302 executes instructions of the data analytics module 310 to modify the term score of the given key term based on feedback data related to a selected system anomaly and event patterns.

Input devices 312 include a keyboard, mouse, data ports, and/or other suitable devices for inputting information into processing system 300. In some examples, input devices 312 are used by the data analytics module 310 to interact with the interactive graphical user interface. Output devices 314 include a monitor, speakers, data ports, and/or other suitable devices for outputting information from processing system 300. In some examples, output devices 314 are used to provide an interactive visual representation of the system anomalies, event patterns, and the word cloud.

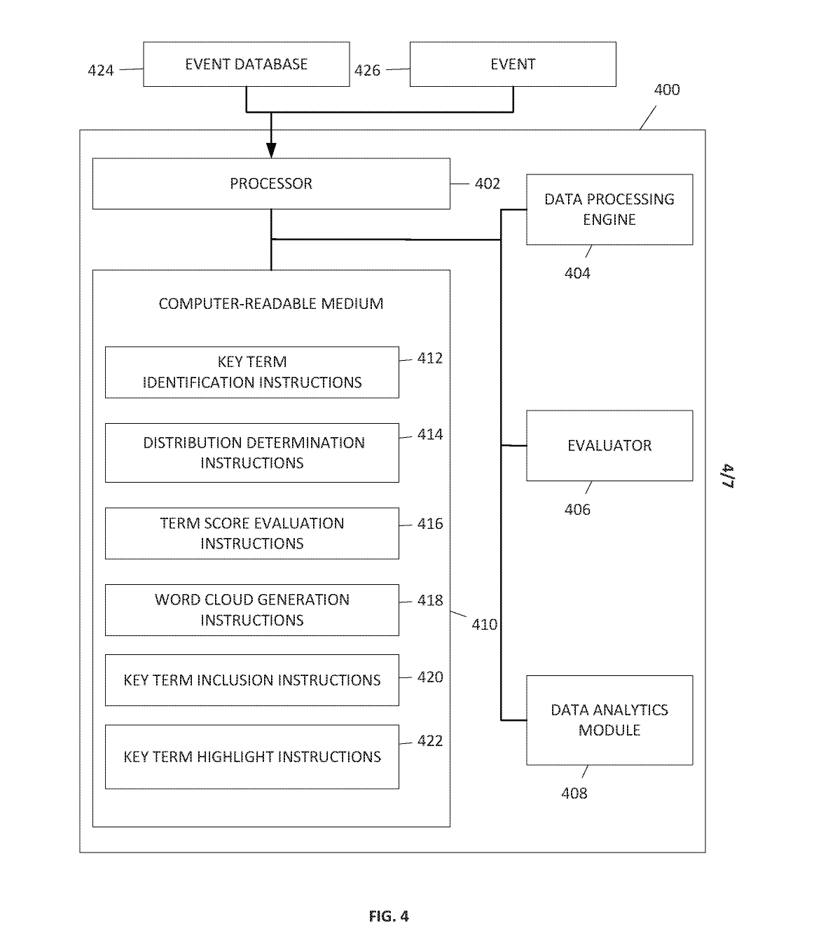

FIG. 4 is a block diagram illustrating an example of a computer readable medium for determining term scores based on a modified inverse domain frequency. Processing system 400 includes a processor 402, a computer readable medium 410, a data processing engine 404, an evaluator 406, and a data analytics module 408. Processor 402, computer readable medium 410, data processing engine 404, evaluator 406, and data analytics module 408, are coupled to each other through communication link (e.g., a bus).

Processor 402 executes instructions included in the computer readable medium 410. Computer readable medium 410 includes key term identification instructions 412 of a data processing engine 404 to identify a key term associated with a system, and a sub-plurality of a plurality of documents, the sub-plurality of documents associated with the event. In some examples, computer readable medium 410 includes key term identification instructions 412 of a data processing engine 404 to identify key terms in a service description for a service case. In some examples, computer readable medium 410 includes key term identification instructions 412 of a data processing engine 404 to identify key terms in log messages associated with a selected system anomaly. In some examples, the key terms associated with the event are included in a document description, such as, for example, service descriptions and log messages.

In some examples, the plurality of documents may be stored in a system database 424. Event data may be data stored in the event database 424. Event data may include, for example, service data related to service cases, or log data related to log messages. In some examples, event data may be received in real-time by processor 402. For example, event data may be received from a call center supporting the IT services for a company.

Computer readable medium 410 includes distribution determination instructions 414 of an evaluator 406 to determine, based on the presence or absence of the key term, a first distribution related to the sub-plurality of the plurality of documents, and a second distribution related to the plurality of documents.

Computer readable medium 410 includes term score evaluation instructions 416 of an evaluator 406 to evaluate, for the key term, a term score based on the first distribution and the second distribution, the term score indicative of a modified inverse domain frequency based on the sub-plurality of the plurality of documents.

Computer readable medium 410 includes word cloud generation instructions 418 of a data analytics module 408 to generate a word cloud based on additional key terms in the sub-plurality of the plurality of documents.

Computer readable medium 410 includes key term inclusion instructions 420 of the data analytics module 408 to include the key term in the word cloud when the term score for the key term satisfies a threshold.

Computer readable medium 410 includes key term inclusion instructions 420 of the data analytics module 408 to highlight, in the word cloud, the key term based on the term score. As used herein, the term “highlight” may refer to displaying the key term in bold, displaying the key term in a distinctive font, such as a larger font relative to other words in the word cloud, and/or not displaying the key term (as when the threshold condition is not satisfied),

Computer readable medium 410 includes key term instructions of the data analytics module 408 to provide, via the processor 402, a potential resolution of a service case based on the ranking of the identified key terms, and previous resolutions associated with the key terms, where data related to the previous resolutions may be retrieved from, for example, the event database 424.

As used herein, a “computer readable medium” may be any electronic, magnetic, optical, or other physical storage apparatus to contain or store information such as executable instructions, data, and the like. For example, any computer readable storage medium described herein may be any of Random Access Memory (RAM), volatile memory, non-volatile memory, flash memory, a storage drive (e.g., a hard drive), a solid state drive, and the like, or a combination thereof. For example, the computer readable medium 410 can include one of or multiple different forms of memory including semiconductor memory devices such as dynamic or static random access memories (DRAMs or SRAMs), erasable and programmable read-only memories (EPROMs electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

As described herein, various components of the processing system 400 are identified and refer to a combination of hardware and programming configured to perform a designated function. As illustrated in FIG. 8, the programming may be processor executable instructions stored on tangible computer readable medium 410, and the hardware may include processor 402 for executing those instructions. Thus, computer readable medium 410 may store program instructions that, when executed by processor 402, implement the various components of the processing system 400.

Such computer readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

Computer readable medium 410 may be any of a number of memory components capable of storing instructions that can be executed by processor 402. Computer readable medium 410 may be non-transitory in the sense that it does not encompass a transitory signal but instead is made up of one or more memory components configured to store the relevant instructions. Computer readable medium 410 may be implemented in a single device or distributed across devices. Likewise, processor 402 represents any number of processors capable of executing instructions stored by computer readable medium 410. Processor 402 may be integrated in a single device or distributed across devices. Further, computer readable medium 410 may be fully or partially integrated in the same device as processor 402 (as illustrated), or it may be separate but accessible to that device and processor 402. In some examples, computer readable medium 410 may be a machine-readable storage medium.

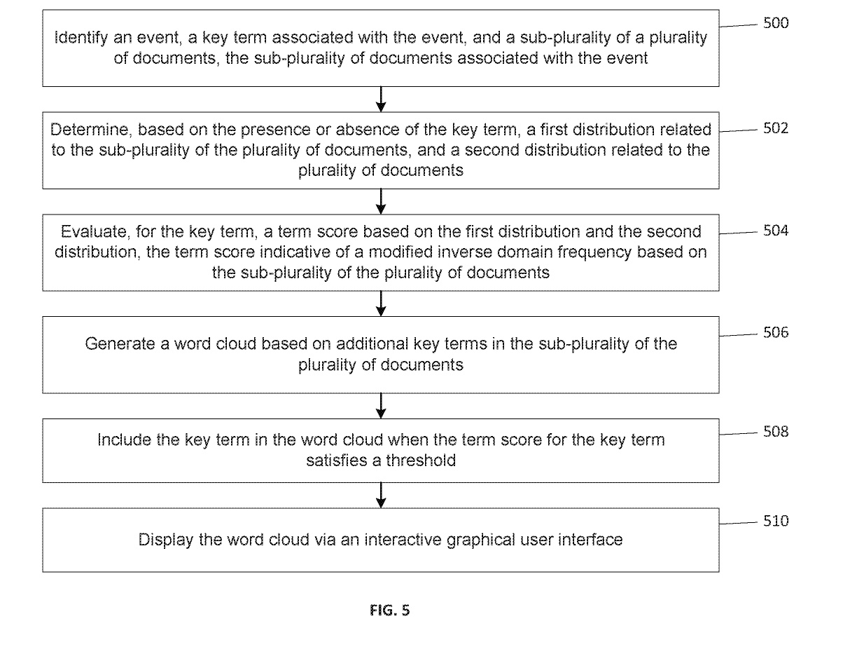

FIG. 5 is a flow diagram illustrating an example of a method for determining term scores based on a modified inverse domain frequency. At 500, a system is identified, a key term associated with the event is identified, and a sub-plurality of a plurality of documents is identified, the sub-plurality of documents associated with the event. At 502, based on the presence or absence of the key term, a first distribution related to the sub-plurality of the plurality of documents, and a second distribution related to the plurality of documents are determined. At 504, a term score for the key term is evaluated based on the first distribution and the second distribution, the term score indicative of a modified inverse domain frequency based on the sub-plurality of the plurality of documents. At 506, a word cloud is generated based on additional key terms in the sub-plurality of the plurality of documents. At 508, the key term is included in the word cloud when the term score for the key term satisfies a threshold. At 510, the word cloud is displayed via an interactive graphical user interface.

In some examples, the event is a selected system anomaly, the plurality of documents are a collection of log messages, and the sub-plurality of the plurality of documents are a sub-collection of the collection associated with the selected system anomaly.

In some examples, the event is a given service case, the plurality of documents are a collection of document descriptions for service cases, and the sub-plurality of the plurality of documents is a document description for the given service case, and the data analytics module further provides a potential resolution of the given service case based on the term score.

In some examples, the term score is one of an information gain and a Kullback-Liebler Divergence.

In some examples, the method further includes modifying the term score of the key term based on feedback data related to the word cloud.

In some examples, the method further includes detecting system anomalies and event patterns based on feedback data related to the interactive word cloud.

In some examples, the term score is based on a term prominence frequency indicative of prominence of the key term in the sub-plurality of documents.

In some examples, the term score is based on based on a term relevance score indicative of relevance of the key term to the event. In some examples, the event is associated with event data that includes structured outcomes, and the evaluator evaluates the term score based on a probability of the key term resulting in an outcome of the structured outcomes. In some examples, the event is associated with event data that includes unstructured outcomes, and the evaluator evaluates the term score based on an outcome metric, the outcome metric indicative of distance between two outcomes of the unstructured outcomes.

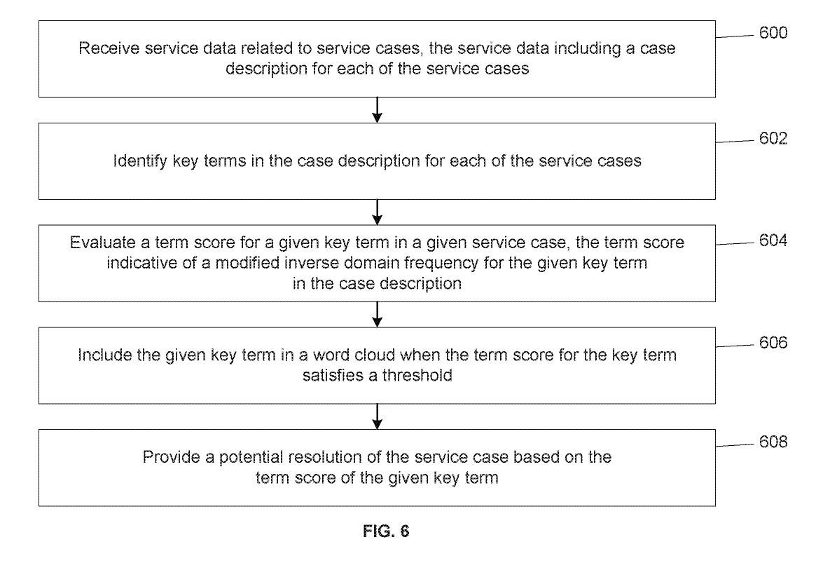

FIG. 6 is a flow diagram illustrating an example of a method for determining term scores in service case resolutions. At 600, service data related to service cases is received, the service data including a case description for each of the service cases. At 602, key terms are identified in the case description for each of the service cases. At 604, a term score is evaluated for a given key term in a given service case, the term score indicative of a modified inverse domain frequency for the given key term in the case description. At 606, the given key term is included in a word cloud when the term score for the key term satisfies a threshold. At 608, a potential resolution of the service case is provided based on the term score of the given key term.

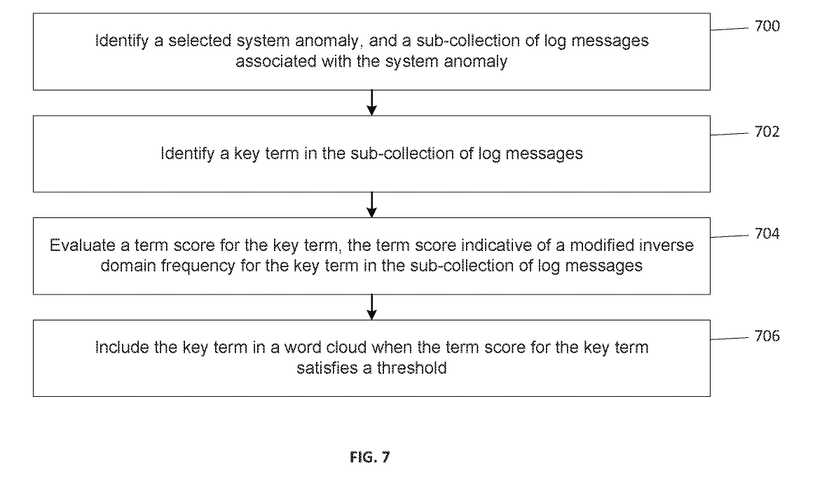

FIG. 7 is a flow diagram illustrating an example of a method for determining term scores in operations analytics. At 700, a selected system anomaly, and a sub-collection of log messages associated with the system anomaly are identified. At 702, a key term in the sub-collection of log messages is identified. At 704, a term score is evaluated for the key term, the term score indicative of a modified inverse domain frequency for the key term in the sub-collection of log messages. At 706, the key term is included in a word cloud when the term score for the key term satisfies a threshold.

Examples of the disclosure provide a generalized system for determining term scores based on a modified inverse domain frequency. The generalized system is based on ranking key terms based on, for example, past resolutions of service cases or previously detected system anomalies. In some examples, the generalized system is based on ranking key terms based on their prominence in a document description, including their position in a document description. Such a generalized system is better equipped to search event data efficiently and accurately to provide, for example, timely resolutions of service cases, and optimized data analytics.

Although specific examples have been illustrated and described herein with respect to event data, the examples illustrate applications determine term scores related to any data. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a data processing engine to identify a key term associated with a system, and a sub-plurality of a plurality of documents, the sub-plurality of documents associated with the event;
an evaluator to:
determine, based on the presence or absence of the key term, a first distribution related to the sub-plurality of the plurality of documents, and a second distribution related to the plurality of documents, and
evaluate, for the key term, a term score based on the first distribution and the second distribution, the term score indicative of a modified inverse domain frequency based on the sub-plurality of the plurality of documents; and
a data analytics module to include the key term in a word cloud when the term score for the key term satisfies a threshold.

2. The system of claim 1, wherein the term score is one of an information gain and a Kullback-Liebler Divergence,

3. The system of claim 1, wherein the data analytics module further displays the word cloud via an interactive graphical user interface, wherein the key term is highlighted based on the term score.

4. The system of claim 3, wherein the evaluator further modifies the term score of the key term based on feedback data related to the word cloud.

5. The system of claim 1, wherein the event is a selected system anomaly, the plurality of documents are a collection of log messages, and the sub-plurality of the plurality of documents are a sub-collection of the collection associated with the selected system anomaly.

6. The system of claim 1, wherein the event is a given service case, the plurality of documents are a collection of document descriptions for service cases, and the sub-plurality of the plurality of documents is a document description for the given service case, and the data analytics module provides a potential resolution of the given service case based on the term score.

7. The system of claim 1, wherein the term score is further based on a term prominence frequency indicative of prominence of the key term in the sub-plurality of documents.

8. The system of claim 1, wherein the term score is further based on a term relevance score indicative of relevance of the key term to the event.

9. The system of claim 8, wherein the event is associated with event data that includes structured outcomes, and the evaluator evaluates the term score based on a probability of the key term resulting in an outcome of the structured outcomes.

10. The system of claim 8, wherein the event is associated with event data that includes unstructured outcomes, and the evaluator evaluates the term score based on an outcome metric, the outcome metric indicative of distance between two outcomes of the unstructured outcomes.

11. A method to generate a word cloud based on a system, the method comprising:
identifying the event, a key term associated with the event, and a sub-plurality of a plurality of documents, the sub-plurality of documents associated with the event;
determining, based on the presence or absence of the key term, a first distribution related to the sub-plurality of the plurality of documents, and a second distribution related to the plurality of documents;
evaluating, for the key term, a term score based on the first distribution and the second distribution, the term score indicative of a modified inverse domain frequency based on the sub-plurality of the plurality of documents;
generating a word cloud based on additional key terms in the sub-plurality of the plurality of documents;
including the key term in the word cloud when the term score for the key term satisfies a threshold; and
displaying the word cloud via an interactive graphical user interface.

12. The method of claim 11, wherein the event is a selected system anomaly, the plurality of documents are a collection of log messages, and the sub-plurality of the plurality of documents are a sub-collection of the collection associated with the selected system anomaly.

13. The method of claim 11, wherein the event is a given service case, the plurality of documents are a collection of document descriptions for service cases, and the sub-plurality of the plurality of documents is a document description for the given service case, and the data analytics module further provides a potential resolution of the given service case based on the term score.

14. The method of claim 11, wherein the term score is one of an information gain and a Kullback-Liebler Divergence.

15. A non-transitory computer readable medium comprising executable instructions to:
identify a key term associated with a system, and a sub-plurality of a plurality of documents, the sub-plurality of documents associated with the event;
determine, based on the presence or absence of the key term, a first distribution related to the sub-plurality of the plurality of documents, and a second distribution related to the plurality of documents;
evaluate, for the key term, a term score based on the first distribution and the second distribution, the term score indicative of a modified inverse domain frequency based on the sub-plurality of the plurality of documents;
generate a word cloud based on additional key terms in the sub-plurality of the plurality of documents;
include the key term in the word cloud when the term score for the key term satisfies a threshold; and
highlight, in the word cloud, the key term based on the term score.
